(19) United States
(12) Patent Application Publication
(10) Pub. No.: US 2005/0162673 A1
(43) Pub. Date: Jul. 28, 2005

(54) Image processing device and program for image processing

(75) Inventor: Tetsuya Suzuki, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/983,100

(22) Filed: Nov. 8, 2004

(30) Foreign Application Priority Data
Nov. 14, 2003 (JP) 2003-384462

(51) Int. Cl. G06F 15/00

(52) U.S. Cl. 358/1.9; 358/3.01

(57) ABSTRACT

An image processing device and program are provided which, while enabling faster overall processing if image data comprises a color image, maintains high quality of printed images. If RGB grayscale data is expanded into band memory 105, if judging from intermediate code the image type is other than a bitmap, the pattern is solid or a binary pattern, and moreover RGB grayscale values are “00000000” (binary) or “11111111” (binary), simplified expansion into band memory of RGB grayscale data as gray data is performed. In other cases, the RGB grayscale data is expanded without modification into band memory 105. In the case of gray data, color conversion processing using a color correction table is not performed, but interpolated values of “00000000” and “11111111” are taken. Thereafter the data is compressed and output from the host computer 1 to a printing device 2, and printing is performed.

### TECHNICAL FIELD

This invention relates to an image processing device such as a printer or photocopier, and to a program which performs image processing. More specifically, this invention relates to an image processing device and program for image processing which perform simple expansion into band memory.

### BACKGROUND ART

When causing a printer to print an image created by a host computer, conventionally the host computer internally comprises a printer driver to control the printer, converting the image data into print data which can be processed within the printer and outputting this print data to the printer. That is, within the printer driver, print data comprising RGB (red, green, blue) grayscale data generated by application software is first converted into an internal code and expanded into band memory, and thereafter color conversion of the RGB grayscale data into CMYK (cyan, magenta, yellow, black) grayscale data is performed, and the result output to the printer.

On the other hand, when performing color conversion within the driver, by referencing different correction tables for color conversion according to the type of drawing (character, graphics, image) in the image to be printed, color vividness may be emphasized, or colors close to natural hues may be emphasized, so as to maintain high quality of the printed image. Consequently when the driver expands the RGB grayscale data into band memory, for example attribute information comprising information on the type of drawing is generated for each pixel and is expanded into band memory together with the RGB grayscale data, and based on this attribute information the table to be referenced for color conversion is selected (see for example Japanese Patent Publication No. 3225506 and Japanese Patent Laid-open No. 2000-165690).

### DISCLOSURE OF THE INVENTION

However, upon expansion into band memory, when the RGB grayscale data is checked and judged to comprise a color image within the image of one page, one page's worth of RGB data is all expanded into band memory, and moreover color conversion processing must be performed, and the entirety of the processing cannot be speeded. For example, when the image of one page comprises a plurality of print objects, even when there exist objects comprising black graphics, the value representing black (“00000000”) must be expanded into the R, G and B band memories for each pixel, and color conversion processing must be performed for this value.

The present invention has as an object the provision of an image processing device and program which maintain high quality of the printed image, while speeding the entirety of the processing when the image to be printed comprises a color image.

In order to attain the above object, this invention concerns an image processing device which performs image processing of image data comprising color data, characterized in having expansion means which expands each of the RGB (red, green, blue) data items constituting image data into band memory as single-color image data in white or black, when the type of the image of image data is other than a bitmap image and the image color is white or black, and color conversion means which reads image data expanded as a single color from band memory, computes interpolated values for the image data, and performs conversion into CMYK (cyan, magenta, yellow, black) of the image data. By this means, an image processing device can be provided in which, for example, image data is not expanded into band memory in each of the three RGB colors, but is expanded as single-color image data, and color conversion into CMYK image data entails only computation of interpolated values, so that faster processing is possible. Further, when the image type is a bitmap, and when the color of a non-bitmap image is other than white or black, color conversion of image data in each of the three RGB colors into CMYK is performed, so that an image processing device which forms high-quality images can be provided.

Also, in order to attain the above object, this invention concerns an image processing device which performs image processing of image data comprising color data, characterized in having intermediate code generation means which generates an intermediate code for expansion of image data into band memory having a prescribed width; expansion means, which judges the type of an image of image data from the intermediate code generated by the intermediate code generation means, and when the type of an image is other than a bitmap, the image comprises a single color or two colors, and the image color is white or black, expands the image data into band memory as single-color white or black image data; and, color conversion means which reads the image data expanded by the expansion means from band memory and performs color conversion. By this means, single-color image data is simply expanded into band memory, so that an image processing device capable of faster processing can be provided. Further, when an image type is a bitmap, or if not a bitmap is other than a solid or binary pattern, or even if a bitmap and a solid or binary pattern does not comprise white or black, color conversion is performed for the three-color image data, so that an image processing device can be provided which forms high-quality images.

Also, in order to attain the above object, this invention concerns a program to perform image processing of image data comprising color data, characterized in causing a computer to execute expansion processing to expand into band memory each of the RGB (red, green, blue) data items constituting image data when the type of the image of image data is other than a bitmap image and the image color is white or black, and color conversion processing to read from band memory the image data expanded as a single color, compute interpolated values for the image data, and perform conversion into CMYK (cyan, magenta, yellow, black) of the image data. By this means, an image processing program can be provided in which, for example, image data is not expanded into band memory in each of the three RGB colors, but is expanded as single-color image data, and color conversion into CMYK image data entails only computation of interpolated values, so that faster processing is possible. Further, when the image type is a bitmap, and when the color of a non-bitmap image is other than white or black, color conversion of image data in each of the three RGB colors into CMYK is performed, so that an image processing program which forms high-quality images can be provided.

Also, in order to attain the above object, this invention concerns a program to perform image processing of image data comprising color data, characterized in causing a computer to execute intermediate code expansion processing to generate an intermediate code for expansion of image data into band memory having a prescribed width; expansion processing to judge the type of an image of image data from the intermediate code generated by the intermediate code generation means, and when the type of an image is other than a bitmap, the image comprises a single color or two colors, and the image color is white or black, to expand the image data into band memory as single-color white or black image data; and, color conversion processing to read the image data expanded by the expansion processing from band memory and perform color conversion. By this means, single-color image data is simply expanded into band memory, so that an image processing program capable of faster processing can be provided. Further, when an image type is a bitmap, or if not a bitmap is other than a solid or binary pattern, or even if a bitmap and a solid or binary pattern does not comprise white or black, color conversion is performed for the three-color image data, so that an image processing program can be provided which forms high-quality images.

### BRIEF DESCRIPTION OF THE DRAWINGS

FIG. 1 shows the configuration of a system to which this invention is applied;

FIG. 2 shows the functional block configuration of a system to which this invention is applied;

FIG. 3 shows an example of the configuration of band memory 105;

FIG. 4 shows an example of the configuration of the color processing portion 106;

FIG. 5 is a flowchart showing image processing operation;

FIG. 6 is a flowchart showing processing operation for expansion into band memory;

FIG. 7A shows an example of a print image;

FIG. 7B shows an example of the drawing record for the image of FIG. 7A;

FIG. 8A shows an example of intermediate code; and,

FIG. 8B shows an example of expansion into band memory of a print image.

### BEST MODE FOR CARRYING OUT THE INVENTION

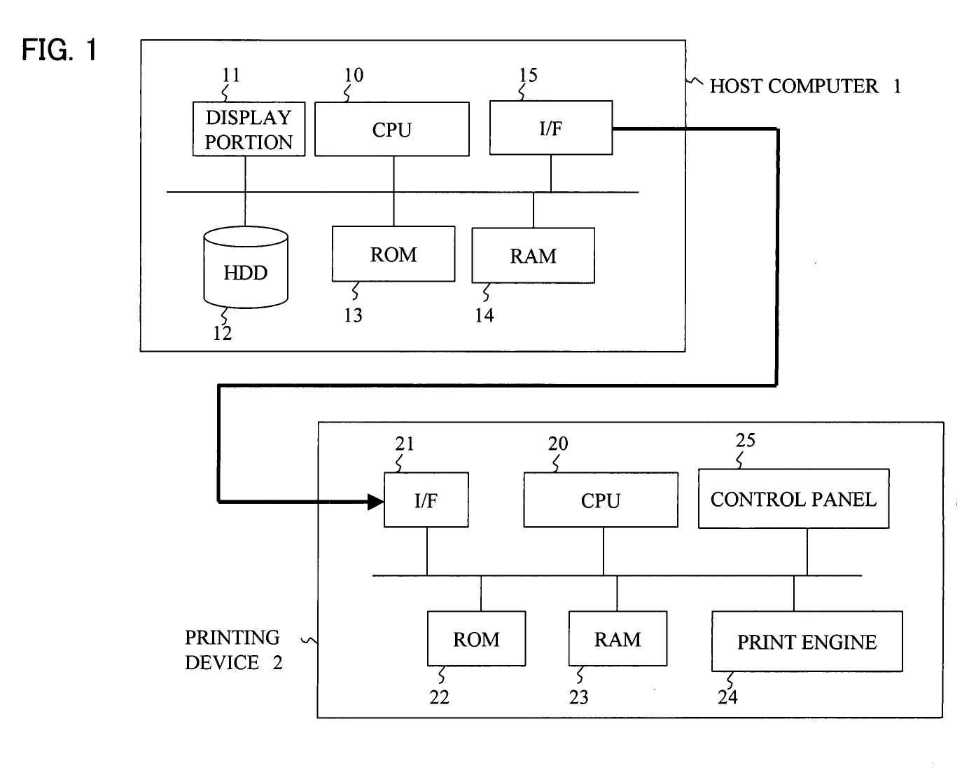

Below, the best modes for carrying out the invention are explained, referring to the drawings. FIG. 1 shows the configuration of a system to which this invention is applied. As shown in FIG. 1, this system comprises a host computer 1 and a printing device 2.

The host computer comprises a CPU 10, display portion 11, HDD (Hard Disk Drive) 12, ROM 13, RAM 14, and interface (I/F) 15, interconnected by a bus. The CPU 10 executes image processing and various other processing within the computer; details are explained below. The display portion 11 displays images for printing and other information, under control of the CPU 10. The HDD 12 stores images for printing and other information; images for printing are stored and read as appropriate under control of the CPU 10. The ROM 13 stores a program to which this invention is applied and programs to perform various processing; programs are read from and executed by the CPU 10 as appropriate. The RAM 14 plays the role of working memory for the CPU 10, and stores execution results of the CPU 10 and similar as appropriate. The I/F 15 converts images for printing into a prescribed transmission format and outputs data to an external device under control of the CPU 10.

In a host computer 1 configured in this way, an image stored on the HDD 12 is caused to be displayed on the display portion 11 under control of the CPU 10, and through operation of the host computer 1 by a user, the CPU 10 reads a program for image processing from the ROM 13. The processing of the program is executed by the CPU 10, and data resulting from image processing is stored in the RAM 14 as appropriate, after which the image for printing is output from the I/F 15.

Next, the printing device 2 is explained. The printing device 2 comprises a CPU 20, interface (I/F) 21, ROM 22, RAM 23, print engine 24, and control panel 25, all interconnected by a bus. The CPU 20 reads a program stored in ROM 22 and executes various processing; details are described below. The I/F 21 receives input of image data for printing which has been output from the host computer 1 in a prescribed transmission format, and converts this data into data which can be processed within the printing device 2. The ROM 22 stores a program for execution by the CPU 20. The RAM plays the role of working memory for the CPU 20, and stores execution results of the CPU 20 and similar as appropriate. The print engine 24 comprises a laser diode and photosensitive drum or similar, and performs actual printing of the image onto print media. The control panel 25 enables specification of the type of print media, number of pages and similar. The control panel 25 may for example comprise a liquid crystal display panel.

In a printing device 2 configured in this way, image data is input from the host computer 1 into the I/F 21 and stored temporarily in RAM 23. The CPU 20 reads a program for printing from ROM 22 as appropriate and executes processing, generating driving data for printing. The driving data is output to the print engine 24 under control of the CPU 20, and the image generated by the host computer 1 is actually printed.

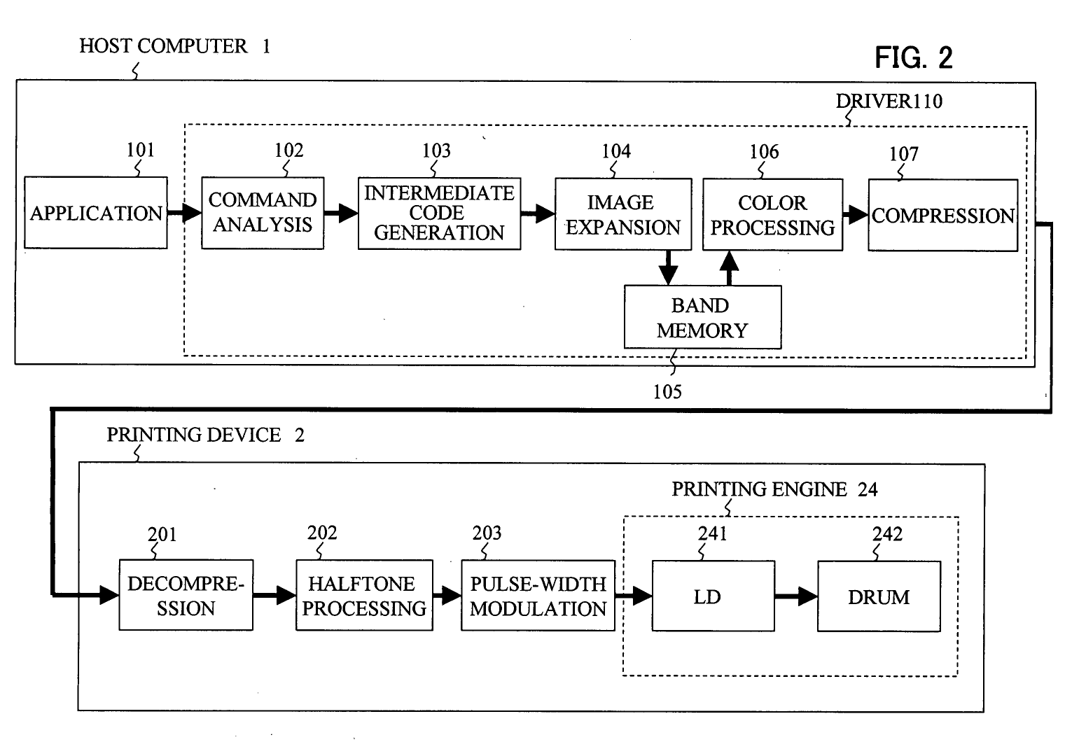

FIG. 2 shows the functional block configuration of the system shown in FIG. 1. The overall configuration from a host computer 1 and printing device 2 is the same as in FIG. 1. As shown in FIG. 2, the host computer 1 comprises an application portion 101 and driver 110. The application portion 101 and driver 110 correspond to the CPU 10, ROM 13, and RAM 14 in FIG. 1.

The application portion 101 generates character data, drawing data, bitmap data, and other data for printing. The CPU 10 reads and executes a word processor, drawing tool, or other application program stored in ROM 13 to generate character, graphics, drawing, and other printing data. This printing data is represented in a prescribed description language. For example, printing data is represented in PDL (Page Description Language), or in a command format using GDI (Graphic Device Interface); details are explained below. The printing data represented by such a language is output to the driver 110 under control of the CPU 10.

As shown in FIG. 2, the driver 110 comprises a command analysis portion 102, intermediate code generation portion 103, image expansion portion 104, band memory 105, color processing portion 106, and compression portion 107. The command analysis portion 102 is connected to the application portion 101, and also connected to the intermediate code generation portion 103. The command analysis portion 102 takes as input printing data described in GDI or another language from the application portion 101, analyzes the command contents, and outputs the results to the intermediate code generation portion 103.

The intermediate code generation portion 103 generates intermediate code and outputs the code to the image expansion portion 104, based on information output from the command analysis portion 102. This intermediate code is mainly information indicating the type of image stored in band memory 105, described below. The image expansion portion 104 takes as input the intermediate code from the intermediate code generation portion 103, and based on this code stores and expands in the band memory 105 the actual RGB grayscale data. The image expansion portion 104 generates attribute information X from the intermediate code, comprising information indicating the type of image, for use in selecting a color correction table and halftone table appropriate to the type of image in the subsequent color conversion processing and halftone processing. The type of image may be character, graphics, or bitmap. This attribute information X is also expanded in the band memory 105. Generation of attribute information X is described in detail below.

In the image expansion portion 104, a decision is made as to whether to perform expansion in band memory from intermediate code (and from RGB grayscale data constituting intermediate code) as RGBX data, or as gray data. RGBX data is RGB grayscale data with attribute information X appended; gray data is white-color data (in the RGB color space, each of the RGB colors is represented by “11111111” (binary)) or black-color data (similarly, each of the RGB colors is represented by “00000000” (binary)), represented by one byte. That is, conventionally the white and black RGB grayscale values are expressed by three bytes, in which each of the RGB colors is represented by the eight bits “11111111” or “00000000”; but gray data is expressed by a single byte, which is “11111111” or “00000000” for white and for black respectively, rather than by three bytes for the RGB colors. Hence when data is expanded in band memory 105 as RGBX data, each color is represented by one byte to total three bytes, plus one byte for attribute information X, resulting in a size of four bytes; but in the case of gray data, the size is one byte (attribute information X is not appended), so that the processing time for expansion into band memory can be shortened to the extent that the amount of data to be stored is reduced. Further, attribute information X is not appended upon expansion as gray data because there is no need to reference a correction table when performing color conversion from gray data into CMYK, and in subsequent halftone processing also, the output values for gray data do not change regardless of whether a resolution-priority or grayscale-priority halftone table is used.

In the image expansion portion 104, a type key is generated indicating whether to use a color correction table to perform color conversion processing, depending on whether RGB grayscale data has been expanded as RGBX data or as gray data. That is, in the color processing portion 106 described below, this type key is used to decide whether to use a color correction table to perform color conversion, or to perform color conversion without using the table. The generated type key is stored in RAM 14 under control of the CPU 10.

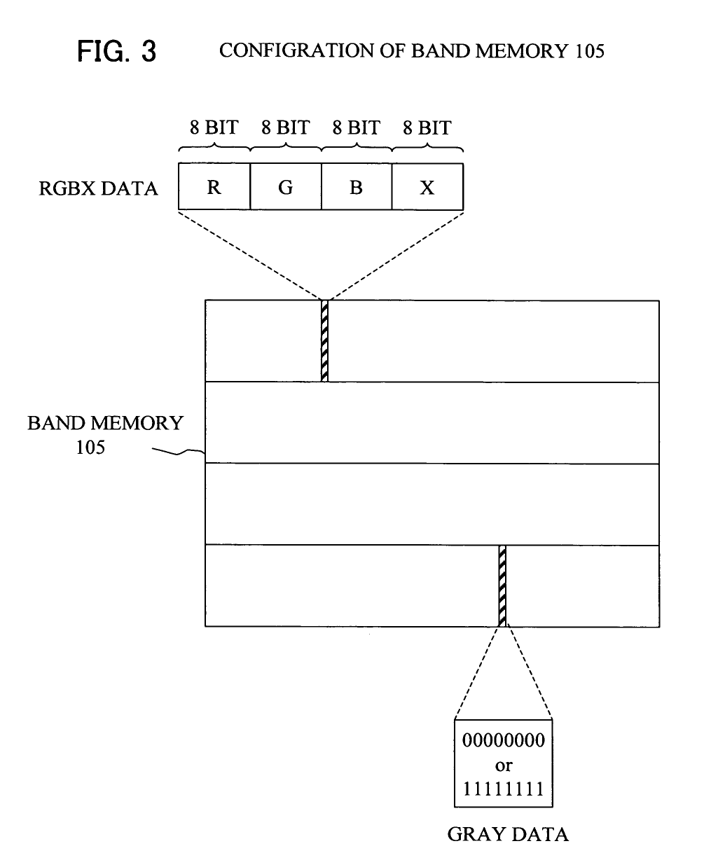

The band memory 105 RGBX data or gray data is input from the image expansion portion 104, and is stored under the control of the CPU 10. FIG. 3 shows an example of the configuration of the band memory 105. In the band memory 105, one page's worth of an image region is divided into a plurality of regions, and each region is configured as one band. By this means, it is no longer necessary that the band memory 105 itself have a capacity of one page, processing can be made more efficient, and the band memory 105 can comprise inexpensive memory.

Each of the values of the RGBX data is represented by eight bits, as described above (having values from 0 to 255 for each RGB color), and these values for each color are stored for each pixel. In the case of gray data, as shown in FIG. 3, eight bits of data (one byte of data) are stored for each pixel. Because the RGB grayscale values are all the same “00000000” or “11111111”, by storing one-byte values, the memory 105 can be made faster and more efficient. Each of the coordinate positions in band memory 105 corresponds to a coordinate position on the print media. Hence by positioning the object image in the corresponding position in memory 105, the desired print image is obtained.

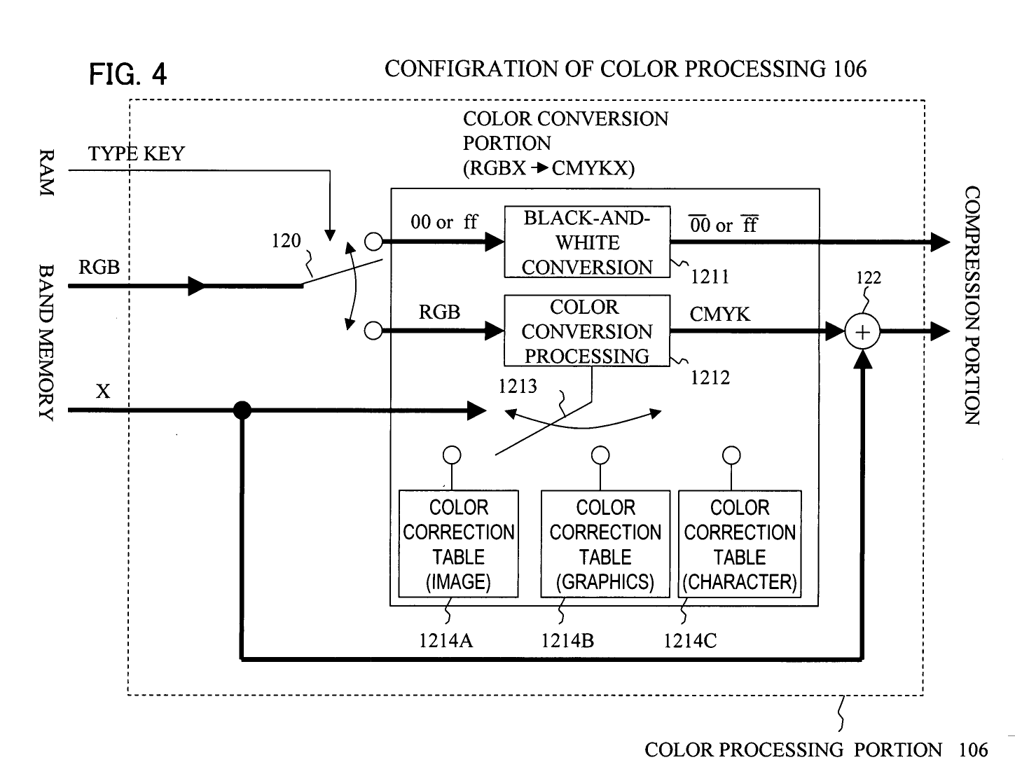

Returning to FIG. 2, the color processing portion 106 inputs RGBX data or gray data from band memory 106 and performs color conversion processing, to generate CMYK grayscale data which is output to the compression portion 107. FIG. 4 shows the specific configuration of the color processing portion 106. As shown in FIG. 4, the color processing portion 106 comprises a first switching portion 120, a color conversion portion 121, and an addition portion 122. The first switching portion 120 is configured to perform switching of the RGB data or gray data read from band memory 105 according to the type key. When the type key indicates that color conversion processing is not to be performed using a color correction table (when the data is expanded as gray data in the band memory 105), switching is performed to output the gray data read from band memory 105 to the black-and-white conversion portion 1211, described below. On the other hand, when the type key indicates that color conversion processing is to be performed using a color correction table (when the data is expanded as RGBX data in the band memory), switching is performed to output the RGB data read from band memory to the color conversion processing portion 1212, described below. The switching by the first switching portion 120 is performed under control of the CPU 10.

The color conversion portion 121 comprises a black-and-white conversion portion 1211 and color conversion portion 1212, second switching portion 1213, and three color correction tables 1214A, 1214B, 1214C. The black-and-white conversion portion 1211 converts gray data, input from the first switching portion 120, into CMYK color space data. That is, the complement of white-color data with the value “ff” (hexadecimal) in the RGB color space is taken to convert to the value “00” (hexadecimal) in CMYK color space, and the complement of data for black with the value “00” (hexadecimal) in RGB color space is taken to convert to the value “ff” (hexadecimal) in CMYK color space. CMYK data converted in this way is output to the compression portion 107.

On the other hand, RGB data output from the first switching portion 120 is input to the color conversion processing portion 1212, the second switching portion 1213 selects one among the three color correction tables 1214A, 1214B, 1214C according to the attribute information X, and color conversion into CMYK data is performed based on the selected table. Because the attribute information X comprises information relating to the type of image of the object (character, graphics, bitmap), the color correction table is selected by the second switching portion 1213 based on this information.

In this embodiment, color conversion processing is performed by conversion processing using tetrahedral interpolation. That is, the CMYK grayscale data items corresponding to each of the RGB grayscale data items input to the color conversion processing portion 1212 are determined from the selected color correction table 1214A through 1214C. However, a table which provides each of the CMYK grayscale values corresponding to all RGB grayscale values would contain a huge amount of data. For example, when each of the RGB grayscale values has 256 values ranging from “0” (decimal) to “255” (decimal), the CMYK grayscale values corresponding to all these combinations will be a number of data items equal to 256 raised to the third power. Hence tables 1214A through 1214C are prepared with each of the RGB grayscale values sampled at prescribed intervals to provide each of the CMYK grayscale values at lattice points. By this means, the amount of memory required to store the tables 1214A through 1214C can be reduced.

In this embodiment, there are in total three types of error correction tables, 1214A through 1214C. Error correction table 1214A has numerous matched colors, and is a table suitable for expression of natural colors, selected when the image type as determined from the attribute information X is bitmap. The color correction table 1214C has few matched colors, is suitable for representation of vivid colors, and is selected when the attribute information X indicates that the image type is character. The table 1214B has a number of matched colors intermediate between those of tables 1214A and 1214C, and is a table capable of expressing values between the two tables 1214A and 1214C; it is selected when the image type in the attribute information X is graphics.

After color conversion, the CMYK grayscale data is output to the addition portion 122. The addition portion 122 adds the attribute information X and the CMYK grayscale data. This is because in halftone processing, the attribute information is necessary when selecting the optimum halftone table according to the image type. The CMYK grayscale data added by the addition portion 122 is output to the compression portion 107.

Returning to FIG. 2, CMYK grayscale data output from the black-and-white conversion portion 1211 and addition portion 122 is input to the compression portion 107, compression processing is performed, and the result is output to the printing device 2. Compression is performed in order to raise the efficiency of transfer of CMYK grayscale data. Compression processing is performed by, for example, assigning symbols of shorter length to codes which appear frequently, and symbols of longer length to codes which appear infrequently, in so-called Huffman encoding. Of course, other compression methods may be used.

The functional block configuration of the printing device 2 appears in FIG. 2. The printing device 2 comprises a decompression portion 201, halftone processing portion 202, pulse-width modulation portion 203, and print engine 24. The decompression portion 201, halftone processing portion 202, and pulse-width modulation portion 203 correspond to the CPU 20, ROM 22, and RAM 23 in FIG. 1.

The compressed CMYK grayscale data output from the host computer 1 is input to the decompression portion 201, which performs expansion (decompression) processing. After decompression, the CMYK data (also including the attribute information X when the data was expanded into band memory 105 as RGBX data) is output to the halftone processing portion 202. The halftone processing portion 202 selects the optimum table from a plurality of halftone tables, according to the type of image in the attribute information X, and generates reproduced image data expressing the halftones of a variable-density image. Table may be, for example, of two types, one a table with fine dots and numerous screen lines, and the other with coarse dots and fewer screen lines. When there is a large number of screen lines, the image can be reproduced faithfully without omitting any fine lines, so that resolution is high; such a table is useful when printing characters and graphics. When there are few screen lines, a greater number of grayscale changes can be reproduced, which is advantageous when printing bitmaps. Hence when the information indicating the image type in the attribute information X is graphics or characters, a table with a large number of screen lines is selected, and when the image type is bitmap, a table with a small number of screen lines is selected. The halftone processing portion 202 computes output values corresponding to CMYK grayscale data in the table (a so-called γ table), and outputs the output values as reproduced image data.

The pulse-width modulation portion 203 takes as input the reproduced image data from the halftone processing portion 202, and generates driving data having or not having laser driving pulses for each dot to be formed on the print media. The generated driving data is output to the print engine 24.

The print engine 24 comprises a laser diode (LD) 241 and photosensitive drum 242. The laser diode 241 takes as input the driving data from the pulse-width modulation portion 212, and irradiates the photosensitive drum 242 with laser light corresponding to the driving data. By this means, a latent image is formed on the drum 242. Development is performed by causing toner in each of the CMYK colors to adhere to the drum 242, and after being conveyed by a transfer belt, not shown, the image is actually printed onto printing paper or other recording media.

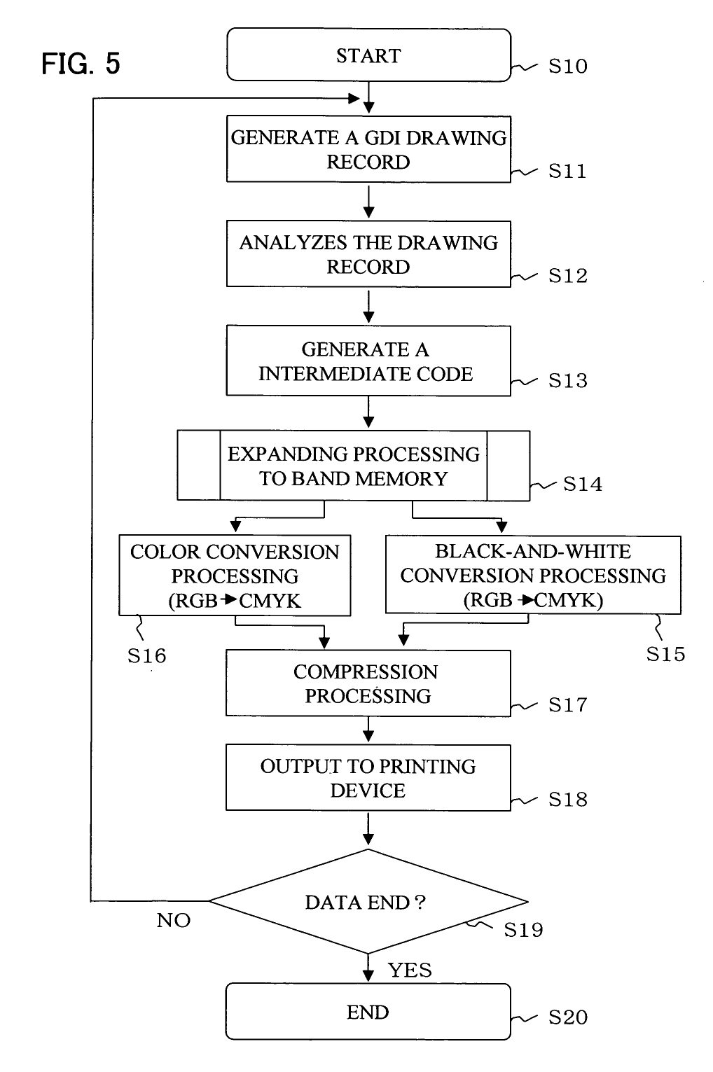

The details of operation of a system to which this invention is applied, configured as described above, is explained. FIG. 5 is a flowchart showing, among this operation, the processing performed within the host computer 1. The CPU 10 of the host computer 1 begins processing by reading a program for execution of this processing from ROM 13 (step S10).

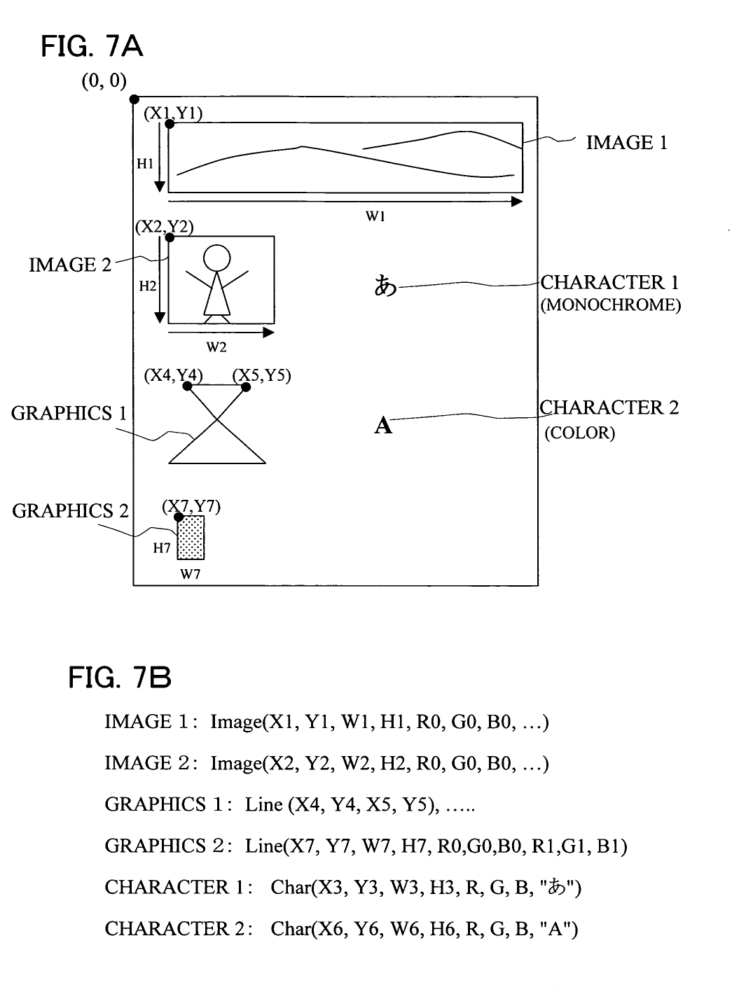

Next, the CPU 10 generates an image or similar for printing, and generates a GDI drawing record representing the image. This GDI drawing record is generated in order to generate the image in the application portion 101, as described above. For example, the case in which the printing image shown in FIG. 7A is generated is explained. As shown in the drawing, the image of one page comprises a image 1, image 2, two characters which are character 1 and character 2, and two graphics which are graphic 1 and graphic 2. A GDI drawing record represents, in command format, one object image.

Of these, the drawing command for image 1 is, as shown in FIG. 7B, “Image (X1, Y1, W1, H1, R0, B0, G0, . . . )”. “Image” indicates that the object image is an image. “X1, Y1” indicate the coordinates of the starting position of image 1, when the origin (0,0) of the image for one page is taken at the upper-leftmost pixel. “W1” indicates the width of image 1, and “H1” indicates the height of image 1. “R0, G0, B0, . . . ” indicate the RGB grayscale values of each of the pixels in image 1. Similarly for image 2, a GDI drawing record is used in which the starting position is represented by “X2, Y2”, the width by “W2”, and the height by “H2”.

The graphic 1 is represented by a plurality of lines, with the coordinates of the starting position at “X4, Y4” and the coordinates of the ending position at “X5, Y5”. The graphic 2 has starting position at coordinates “X7, Y7”, and is of width “W7” and height “H7”. Graphic 2 is a rectangular shape, comprising a plurality of black dots on a white background. This graphic image is called a binary pattern. Hence in order to represent the graphic using two-color RGB crystal values, the drawing record for graphic 2 becomes “R0, G0, B0, R1, G1, B1”.

The character 1 is represented by the command “Char” indicating a character; the arguments are “X3, Y3” indicating the starting position, the width “W3”, height “H3”, and the RGB grayscale values “R, G, B” indicating the color of the character. Likewise, character 2 is represented by the command “Char” with as arguments the starting position “X6, Y6”, width “W6”, height “H6”, and RGB grayscale values “R, G, B”. Here, character 1 is monochrome data (with RGB values either “00000000” (binary) or “11111111” (binary)), and character 2 is color data (data other than monochrome data). A drawing command generated in this way is stored temporarily in for example RAM 14, under the control of the CPU 10.

Returning to FIG. 5, when such a drawing record is generated, the CPU 10 then analyzes the drawing record (step S12). As described above, this processing is performed by the command analysis portion 102 in FIG. 2. The generated drawing command is read from RAM 14, and information indicating whether the object image is a character, a graphic, a image, or similar, is generated from the drawing record command and similar.

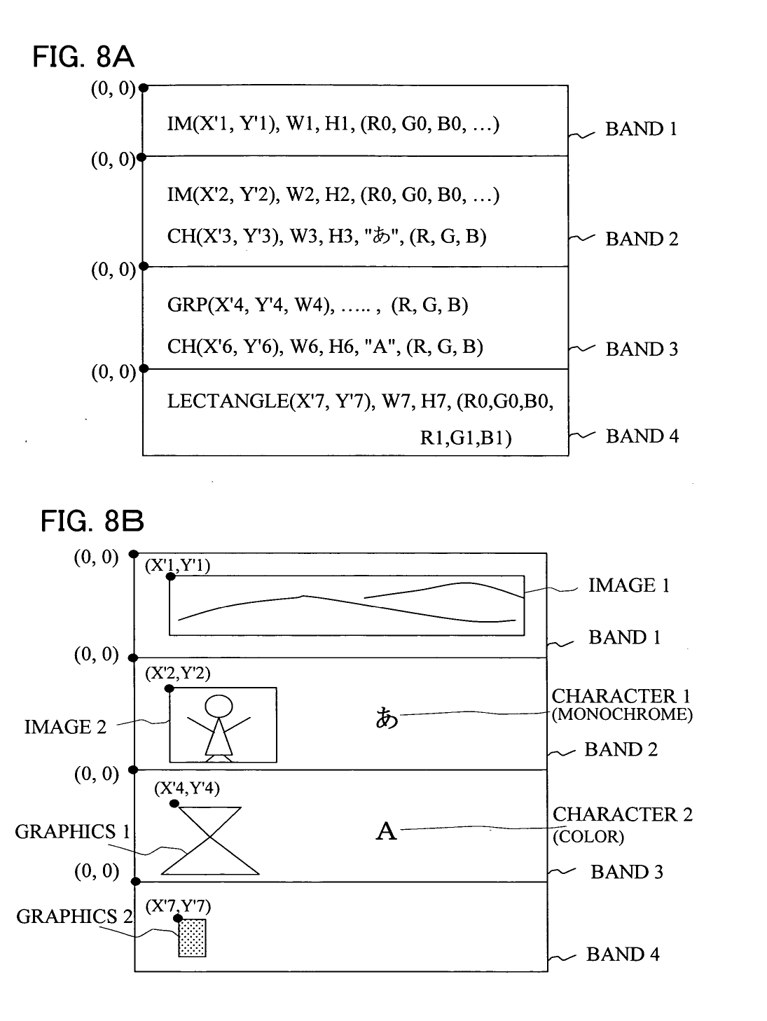

Then, the CPU 10 generates intermediate code from the analyzed drawing record (step S13). This processing is performed by the intermediate code generation portion 103 in FIG. 2. FIG. 8A shows an example of intermediate code generated from the drawing record of FIG. 7B. As shown in FIG. 8A, the intermediate code is generated for each band. In band 1 only the image 1 of FIG. 7A exists; the intermediate code is represented by “IM(X′1, Y′1), W1, H1, (R0, G0, B0, . . . )”. Here “IM” indicates that the image type is an image, and “X′1, Y′1” indicate the starting position in band memory 1. “W1” is the width of the image 1, “H1” is the height of the image 1, and “R0, G0, B0, . . . ” are RGB grayscale values for each of the pixels of the image 1.

In band 2, the image 2 and character 1 in FIG. 7A exist. The image 2 is processed in substantially the same way as image 1. However, the coordinates of the starting position are the starting position of band 2, that is, the origin (0,0) in band 2 is the upper-leftmost position in band 2. The intermediate code for character 1 is “CH(X′3, Y′3), W3, H3, “ [symbol] ”, (R, G, B)”. “CH” indicates that the image type is character; “(X′3, Y′3)? is the coordinate position of the starting point of character 1; “W3” is the width and “H3” the height of character 1; and “(R, G, B)” indicates the color of character 1. In this case, each of the RGB values is either “00000000” (binary) or “11111111” (binary). The coordinate position of the starting point is again the position relative to the origin (0,0), which is the upper-leftmost position in band 2. [symbol] identifies the character of character 1.

The graphic 1 and character 2 shown in FIG. 7A exist in band 3. The graphic 1 is represented by “GRP(X′4, Y′4, W4), . . . ”. Here “GRP” indicates that the image type is graphic, “X′4, Y′4” is the starting point of graphic 1, and “W4” denotes the width from the starting point. The graphic 1 is formed comprising a plurality of lines each having a certain length from the starting point. Hence a plurality of intermediate codes expressed by “GRP( )” are generated so as to form graphic 1. Because character 2 is also in band 3, the intermediate code “CH(X′6, Y′6), W6, H6, “A”, (R, G, B)” is also generated. This is substantially the same as character 1, but the starting point is different.

The graphic 2 shown in FIG. 7A exists in band 4. The intermediate code for graphic 2 is “LECTANGLE (X′7, Y′7), W7, H7, (R0, G0, B0), (R1, G1, B1)”. “LECTANGLE” indicates that graphic 2 is a rectangular-shaped graphic figure. The starting point, width, and height are similar to those explained above for intermediate code. Because graphic 2 is a binary pattern, the RGB grayscale value be of two types. Hence there are two RGB grayscale values, “(R0, G0, B0), (R1, G1, B1)”.

Returning to FIG. 5, after the CPU 10 generates the above-described intermediate code (step S13), the CPU 10 performs processing for expansion into the band memory 105 (step S14). Here, upon expansion into the band memory 105, a judgment is made as to whether to expand RGB grayscale data without modification, or whether to perform expansion as gray data. This is because if expansion is performed as gray data, the amount of data written to the memory 105 is reduced, and color conversion processing does not use a table, so that print processing can be performed more rapidly. As a result, color printing can for example be performed at speeds comparable to monochrome printing.

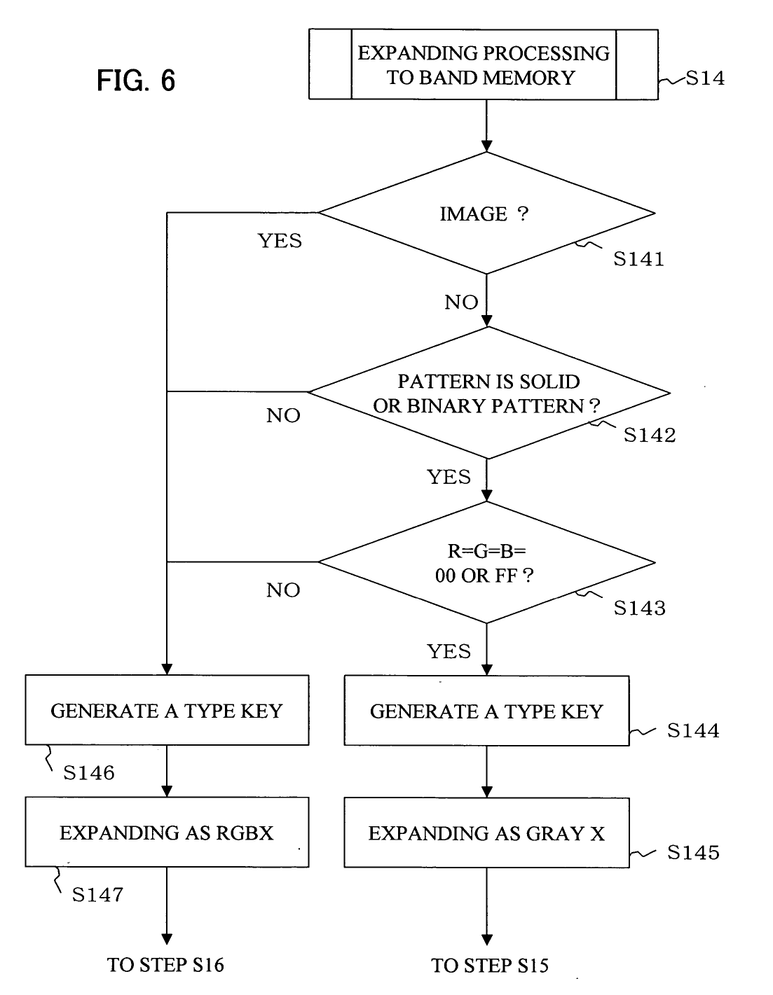

Details of processing for expansion into band memory appear in FIG. 6. First, the CPU 10 judges whether or not the image type is image. This is because a bitmap image must be color-converted to reproduce natural colors. Specifically, the CPU 10 performs judgments according to the “IM”, “GRP”, “CH” and similar character strings in the intermediate code generated in step S13. That is, if the intermediate code comprises “IM”, the image type can be judged to be image; if comprising “GRP” or “LECTANGLE”, the image type can be judged to be graphic; and if comprising “CH”, the image type can be judged to be character. If “IM”, “YES” is selected in this step and processing proceeds to step S146; when “GRP”, “LECTANGLE” or “CH”, “NO” is selected and processing proceeds to step S142.

In step S142, the CPU 10 judges whether the pattern is solid or is a binary pattern. “Solid” refers to a single color; a binary pattern, as explained above, has two colors. The CPU 10 performs a judgment by reading the RGB grayscale values in the intermediate code. That is, if there is only one RGB grayscale value, the pattern is judged to be solid, and if there are two values, the pattern is judged to be a binary pattern. For example, graphic 1 comprises a single color, and the intermediate code has only one RGB grayscale value “(R, G, B)”, and so graphic 1 has a solid pattern. And, graphic 2 has two RGB grayscale values “(R0, G0, B0, R1, G1, B1)”, and so can be judged to be a binary pattern. If the pattern is a solid or binary pattern, “YES” is selected in this step, and processing proceeds to step S143. If an image is a graphic or character and has other than a solid or binary pattern, such as for example if a repeating pattern is formed in the graphic, it is necessary to perform color correction and other processing, so that “NO” is selected in this step, and processing proceeds to step S146.

In step S143, the CPU 10 judges whether R=G=B=“00000000” (binary) or “11111111” (binary) (in hexadecimal, “00” or “ff”). This is to judge whether the color is white or black. This is because even if the image type is graphic or character, and comprises a solid or binary pattern, if the actual color is other than white or black, a color correction table should be used to perform color conversion. In this step also, the CPU 10 can perform judgment by reading each of the RGB grayscale values in the intermediate code and judging according to whether the values are “00000000” (binary) or “11111111” (binary). If the color is white or black, “YES” is selected in this step, and processing proceeds to step S144. If other than white or black, “NO” is selected in this step, and processing proceeds to step S146.

In step S144, the CPU 10 generates a type key. As explained above, the type key indicates whether or not a color correction table is used to perform color conversion. In this step S144, the type key is generated indicating that color conversion is not performed. As explained above, the generated type key is stored in RAM 14 under the control of the CPU 10.

Next, the CPU 10 expands the RGB grayscale data, as gray data, in the band memory 105. That is, rather than expanding into band memory 105 each of the RGB grayscale values, “00000000” (binary) or “11111111” (binary), instead the 8 bit values “00000000” or “11111111” are themselves expanded. If processing for expansion into band memory 105 ends, processing proceeds to step S15.

On the other hand, if “YES” is selected in step S141 and “NO” is selected in steps S142 and S143, in step S146 the CPU 10 generates a type key. As opposed to the type key of step S144, however, a type key is generated indicating that a color conversion table is to be used to perform color conversion. The generated type key is similarly stored in RAM 14. Processing then proceeds to step S147, and the CPU 10 expands the RGB grayscale values and attribute information X into band memory 105. If expansion processing ends, processing proceeds to step S16.

Through expansion into band memory 105, the manner of printing onto the print media is determined, and thereafter the CPU 10 performs color conversion into CMYK data of the gray data or the RGB grayscale data. FIG. 8B shows an example of the image when the intermediate code of FIG. 8A is expanded into band memory 105.

Returning to FIG. 5, if expansion processing (step S14) ends, processing is performed for conversion into CMYK grayscale data (steps S15, S16). Here, if data is expanded into band memory 105 as gray data (step S145 in FIG. 6), black-and-white conversion processing is performed to take the interpolated values of input values (step S15). If performing expansion as RGBX data (step S147 in FIG. 6), a color correction table is used to perform color conversion processing (step S16). Black-and-white conversion processing, as explained above (see FIG. 4), entails taking the interpolation of the gray data “00000000” (binary) or “11111111” (binary), to output, as CMYK grayscale data, “11111111” (binary) or “00000000” (binary), respectively. As explained above, color conversion processing entails processing using tetrahedral interpolation, employing the attribute information X to select a correction table 1214A to 1214C according to the image type, to obtain CMYK grayscale values corresponding to RGB grayscale values. If conversion into CMYK data ends, processing proceeds to step S17.

In step S17, the CPU 10 performs compression processing. As explained above, data compression is performed by encoding the CMYK grayscale data using a Huffman code or similar. The compressed CMYK grayscale data is then output to the printing device 2 (step S18). If one page's worth of CMYK grayscale data is generated (“YES” in step S19), this processing ends (step S20), and if data remains, processing returns to step S11 and the above-described processing is repeated.

Through the above processing, compressed CMYK grayscale data (if expanded in band memory as RGBX data, also including attribute information X) is output to the printing device 2 from the host computer 1. In the printing device 2, decompression is performed by the decompression portion 201, and reproduced image data forming a variable-density image is generated by the halftone processing portion 202. If expanded as RGBX data, the CMYK grayscale data is selecting either a resolution-priority halftone table or a grayscale-priority halftone table, according to the attribute information X. If expanded as gray data, the CMYK grayscale data (in this case, “11111111” or “00000000”) can be processed using either table. This is because in halftone processing using a γ table, because of the γ characteristic representing the relation between input values and output values (a characteristic such that, if input values are near “0” (decimal) the output values rise rapidly, and as input values approach “255” (decimal) the output values change so as to gradually approach “255”) the input values “0” (in binary representation, “00000000”) and “255” (in binary representation, “11111111”) are unaffected by the characteristic, and whichever table is selected, the output values do not change.

The generated reproduced image data is then used by the pulse-width modulation portion 203 to generate driving data to generate dots, and the print engine 24 is used to perform printing on print media.

As explained above, by means of this invention, if the type of an image for printing is a graphic or character, and moreover comprises a solid or binary pattern, and moreover RGB grayscale values are “0” (decimal) or “255” (decimal), one byte of grayscale values can be expanded rather than expanding all the RGB values into band memory 105, so that image processing can be made faster and the speed of printing operations can be increased, and moreover high-quality images can be printed.

In the above-described example, expansion into band memory 105 and color processing are performed by a host computer 1; however, the above-described advantageous results can be obtained even when for example the expansion and processing are performed for example by the printing device 2. Further, as the host computer 1, a personal computer, a portable telephone, PDA (Personal Digital Assistant), or other portable information terminal may be used.

The example of a laser printer as a printing device 2 was explained, but the advantageous results of this invention can be obtained when the printing device is an inkjet printer, BubbleJet (a registered trademark) printer, fax machine, photocopier, or multifunctional device comprising a plurality of functions.

Moreover, an example was explained in which processing using a γ table was employed as an example of halftone processing; but in addition, dithering methods, in which the grayscale values of each pixel are compared with threshold values in a threshold matrix to generate reproduced image data indicating the presence or absence of dots, error diffusion methods, in which by similarly comparing threshold values reproduced image data is generated, and in addition differences are diffused among unprocessed pixels in the vicinity and values including the differences compared with threshold values, and other methods of halftone processing may be used.

1. An image processing device, which performs image processing of image data comprising color data, comprising:
expansion portion for expanding each of RGB (red, green, blue) data constituting the image data into a band memory as single-color white or black image data, if an image type of the image data is other than an image and a color of the image is white or black; and,
color conversion portion for reading from the band memory the image data expanded as single-color data, for computing interpolated values of the image data, and for performing conversion into CMYK (cyan, magenta, yellow, black) image data.

2. The image processing device according to claim 1, wherein the expansion portion judges whether a color of a graphic image are a single color which is white or black, or whether the colors of the graphic image are the two colors white and black, if the image type is the graphic image and the graphic image comprises a single color or two colors.

3. The image processing device according to claim 1, wherein the expansion portion judges whether a color of a character image is white or black, if the image type is the character image.

4. The image processing device according to claim 1, wherein the expansion portion judges that the colors of the image are not white or black, if the image type is detected to be the image.

5. The image processing device according to claim 1, wherein the expansion means judges that a color of a graphic image are not white or black, if the image type is the graphic image and the graphic image comprises a repeating pattern of three or more colors.

6. An image processing device, which performs image processing of image data including color data, comprising:
intermediate code generation portion for generating intermediate code for expanding the image data into a band memory having a prescribed width;
expansion portion for judging an image type of the image data from the intermediate code generated by the intermediate code generation portion, and for expanding the image data into a band memory as single-color white or black image data, if the image type is other than a image, a colors of the image data are a single color or two colors, and the color of the image data is white or black; and,
color conversion portion for reading from the band memory the image data expanded by the expansion portion, and for performing color conversion.

7. The image processing device according to claim 6, wherein the color conversion portion computes interpolated values of the single-color or black image data, and performs conversion into CMYK (cyan, magenta, yellow, black) image data.

8. A program causing a computer to execute image processing of image data including color data, the image processing comprising:
expansion processing for expanding each of the RGB (red, green, blue) data constituting the image data into a band memory as single-color white or black image data, if a image type of the image data is other than an image and a color of the image data is white or black; and,
color conversion processing for reading from the band memory the image data expanded as single-color data, computing interpolated values of the image data, and performing conversion into CMYK (cyan, magenta, yellow, black) image data.

9. A program causing a computer to execute image processing of image data including color data, the image processing comprising:
intermediate code generation processing for generating intermediate code for expansion of the image data into a band memory having a prescribed width;
expansion processing for judging an image type of the image data from intermediate code generated by the intermediate code generation processing, and for expanding the image data into the band memory as single-color white or black image data, if the image type is other than an image, colors of the image data are a single color or two colors, and the color of the image data is white or black; and,
color conversion processing for reading from the band memory the image data expanded in the expansion processing, and for performing color conversion.
